(19) United States
(12) Patent Application Publication
(10) Pub. No.: US 2026/0299118 A1
(43) Pub. Date: Oct. 1, 2026

(54) Scanning Systems and Methods

(71) Applicant: Spectrohm, Inc., McLean, VA (US)

(72) Inventors: Timothy Lawrence Cargol, McLean, VA (US); Leo Soloman Ludwick, Potomac, MD (US); Eric Gray Huckabee, II, Potomac, MD (US); Adam Wayne Dudycha, Paw Paw, MI (US); Eve Berndt, Milwaukee, WI (US); Aaron Michael Betker, Kalamazoo, MI (US)

(73) Assignee: Spectrohm, Inc., McLean, VA (US)

(21) Appl. No.: 19/094,003

(22) Filed: Mar. 28, 2025

(51) Int. Cl. G01S 13/88; G01G 19/52; G01S 13/86; G01B 15/00

(52) U.S. Cl. CPC G01S 13/887; G01G 19/52; G01S 13/867; G01B 15/00

(57) ABSTRACT

Systems and methods are disclosed for scanning an object. The system may include a platform configured to support an object, a base configured to engage a ground surface, and a linkage coupled to the platform allowing movement relative to the base. The system may include at least one side member configured to connect to the base, and at least one sensor configured to collect data about the object. The system may be adjustable between a first state where the at least one side member is extended relative to the base, and a second state where the at least one side member is not extended. In the first state, the platform may move along a path that extends above the at least one side member and the base.

### FIELD OF THE DISCLOSURE

Various aspects of the present disclosure relate generally to systems and methods for scanning objects.

### BACKGROUND

Scanning systems play a crucial role in security and inspection processes across numerous industries and public spaces. Traditional scanning systems often involve large, stationary equipment that may be impractical for use in dynamic or space-constrained environments. The weight and size of large, fixed, scanning platforms may make transportation and dynamic deployment cumbersome and costly. Additionally, many existing portable scanning solutions may lack the flexibility to adapt to different operational requirements or physical settings.

Scanning systems may also utilize tracks or similar components to facilitate movement or positioning of scanning equipment. These track-based systems can accumulate debris, dust, or other contaminants over time. In some cases, this accumulation may lead to operational issues. The presence of foreign material in the tracks may require regular maintenance and cleaning to ensure optimal performance.

The increasing need for security screening in diverse locations, such as temporary events, mobile checkpoints, or areas with limited infrastructure, has highlighted the limitations of conventional scanning equipment. There is a growing demand for scanning solutions that can combine portability, adaptability, and effective detection capabilities without compromising on safety or ease of use.

Moreover, the speed and efficiency of scanning processes have become increasingly important in high-traffic environments. Many existing systems may create bottlenecks in the flow of people or goods, leading to delays and reduced operational efficiency. This has emphasized the need for scanning technologies that can maintain high throughput rates while still providing thorough and accurate screening.

In light of these challenges, there is a need for innovative scanning systems that can address the limitations of current technologies and meet the evolving demands of various screening applications.

The present disclosure is directed to overcoming one or more of these above-referenced challenges.

### SUMMARY

The following description presents a simplified summary in order to provide a basic understanding of some aspects described herein. This summary is not an extensive overview of the claimed subject matter. It is intended to neither identify key or critical elements of the claimed subject matter nor delineate the scope thereof.

In some embodiments, a system for scanning an object may be provided. The system may include a platform that may be configured to support an object to be scanned, a base that may be configured to engage a ground surface, and a linkage that may be coupled to the platform, wherein the linkage may allow the platform to move relative to the base. The system may also include at least one side member that may be configured to connect to the base at a side of the base, and at least one sensor that may be configured to collect data about the object. The system may be adjustable between a first state wherein the at least one side member is extended relative to the base, and a second state wherein the at least one side member is not extended relative to the base. When the system is in the first state, the platform may be configured to move along a path that extends above the at least one side member and the base.

In some embodiments, the system may include one or more of the following features. When the system is in the first state, the at least one side member may be configured such that the system has a first length, and when the system is in the second state, the at least one side member may be configured such that the system has a second length, wherein the second length is less than the first length. The at least one side member may comprise a first side member that may be configured to connect to the base at a first side of the base and a second side member that may be configured to connect to the base at a second side of the base, and when the system is in the first state, the first and second side members may be substantially parallel to a top surface of the base and the platform may be configured to move along a substantially linear path that extends at least partially between the first side member and the second side member. The linkage may be configured to support the weight of the object on the platform.

In some embodiments, the system may further comprise a processor that may be configured to receive the data collected by the at least one sensor, and derive information about the object from the received data. The processor may be further configured to analyze the derived information about the object and generate a risk estimation based on the analysis. The system may further comprise at least one weight sensor that may be configured to collect data indicative of a weight of the object. The at least one weight sensor may include a plurality of load cells. The at least one weight sensor may comprise a plurality of weight sensors, wherein each of the plurality of weight sensors may be positioned proximate a respective fixed bearing point of the linkage.

In some embodiments, the linkage may be configured to move the platform such that the object supported on the platform may move past the at least one sensor, and the movement of the platform provided by the linkage may activate the at least one sensor. The at least one side member may be removably connected to the base. The at least one side member may be pivotably connected to the base. The linkage may comprise a first pivot member that may be pivotally connected to the base at a first pivot point, a second pivot member that may be pivotally connected to the base at a second pivot point, a third pivot member that may be connected to the first member and may be pivotally connected to the base at a third pivot point, and a fourth pivot member that may be connected to the second member and may be pivotally connected to the base at a fourth pivot point. The third pivot member may be connected to the platform at a first attachment point, and the fourth pivot member may be connected to the platform at a second attachment point.

In some embodiments, the at least one side member may comprise a surface with one or more perforations. The at least one side member may be configured to extend beyond a range of movement of the platform in a distal direction when the system may be in the first state.

In some embodiments, a method for scanning an object may be provided. The method may include providing a system comprising a platform that may be configured to support an object to be scanned, a base that may be configured to engage a ground surface, a linkage that may be coupled to the platform, wherein the linkage may allow the platform to move relative to the base, at least one side member that may be configured to connect to the base at a side of the base, and at least one sensor that may be configured to collect data about the object. The method may also include adjusting the system between a first state wherein the at least one side member is extended relative to the base, and a second state wherein the at least one side member is not extended relative to the base. The method may further include positioning the object on the platform, moving the platform along a path that may extend above the at least one side member and the base when the system is in the first state, and collecting data about the object using the at least one sensor.

In some embodiments, the method may include one or more of the following features. When the system is in the first state, the at least one side member may be configured such that the system has a first length, and when the system is in the second state, the at least one side member may be configured such that the system has a second length, wherein the second length is less than the first length. The at least one side member may comprise a first side member that may be configured to connect to the base at a first side of the base and a second side member that may be configured to connect to the base at a second side of the base, and when the system is in the first state, the first and second side members may be substantially parallel to a top surface of the base and the platform may be configured to move along a substantially linear path that extends at least partially between the first side member and the second side member. The linkage may be configured to support the weight of the object on the platform.

Further variations encompassed within the systems and methods are described in the detailed description of the invention below.

### BRIEF DESCRIPTION OF THE DRAWINGS

The accompanying drawings, which are incorporated in and constitute a part of this specification, illustrate various exemplary aspects and together with the description serve to explain the principles of the disclosed technology.

FIG. 1 depicts an exemplary scanning system.

FIG. 2 depicts an additional view of an exemplary scanning system.

FIG. 3 depicts an additional view of an exemplary scanning system.

FIG. 4 depicts an additional view of an exemplary scanning system.

FIG. 5 depicts an additional view of an exemplary scanning system.

FIG. 6 depicts an exemplary method for scanning an object.

FIG. 7 depicts an exemplary system that may execute techniques presented herein.

### DETAILED DESCRIPTION

In general, the present disclosure is directed to systems and methods for scanning objects. In some embodiments, the disclosure is directed to portable scanning systems with adjustable configurations for efficiently screening items in various environments.

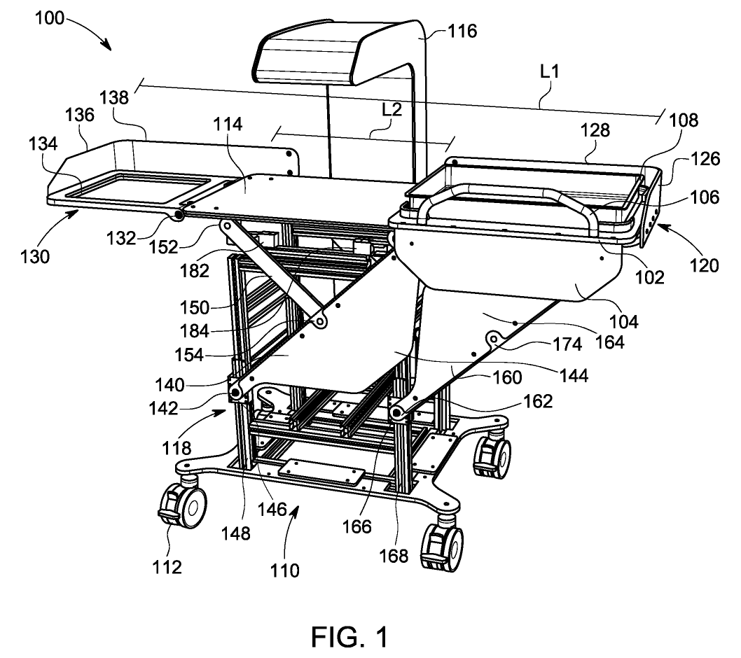

FIG. 1 depicts an exemplary scanning system 100. The scanning system 100 may include a platform 102 configured to move in a path. The platform 102 may be supported and/or surrounded by one or more side guards 104. One or more handles 106 may extend from the platform 102, and a tray 108 may be positioned on the platform 102. The scanning system 100 may include a base 110 that may be equipped with one or more wheels 112 for mobility.

In some embodiments, the base 110 may include a table top 114 and a housing member 116 extending at least partially upward and extending at least partially over the table top 114. The housing member 116, base 110, and/or table 114 may include one or more sensors configured to collect data about an object (e.g., an item of baggage) positioned within the tray 108 on the movable platform 102. In some embodiments, one or more sensors may be arranged within or on the housing member 116 to capture information about the object as the platform 102 moves. In some embodiments, one or more sensors may be arranged under or attached to a bottom surface of the table top 114 to capture information about the object as the platform 102 moves. In some embodiments, the sensors may include one or more cameras, optical sensors, infrared sensors, or other types of sensors capable of gathering data about the object's characteristics. In some embodiments, the one or more sensors may include a sensor array including one or more radar or radio wave or frequency sensors configured to collect data indicative of objects within the item of baggage and/or one or more optical depth sensors (e.g., a time-of-flight sensor, stereo camera, or projected light sensor) configured to collect data indicative of the size of the item of baggage. In some embodiments, a first radar sensor may operate in the mm-wavelength range. In some embodiments, a second radar sensor may operate in the microwave wavelength range. In some embodiments, a radio wave sensor may operate in the UHF, in the VHF, or in the HF range.

In some embodiments, at least one side member may be configured to connect to a side of the base. In some embodiments, a first side member 120 may be configured to connect to a first side of the base 110. In some embodiments, a second side member 130 may be configured to connect to a second opposite side of the base 110. In some embodiments, the first side member 120 may be a folding member configured to pivotably attach to the base unit at one or more pivot points 122 and the second side member 130 may be a folding member configured to pivotably attach to the base unit at one or more pivot points 132. This configuration may allow the side members to be adjusted between a first extended position and a second non-extended or retracted position relative to the base unit. In some embodiments, each side member may be attached to a respective side of the base unit through two pivot points. This configuration may provide additional stability and support for the side members during their movement between extended and retracted positions.

In some embodiments, the ability to retract the side members may allow for more compact storage or transportation of the scanning system when not in use. The adjustable nature of the one or more side members may enable the system to be configured in a more space-efficient manner during periods of non-operation or when being moved between locations. This feature may provide flexibility in terms of storage options and may facilitate easier transport of the scanning system in vehicles or through doorways with limited clearance. The compact state may also be advantageous in environments where space is at a premium, allowing the system to occupy a smaller footprint when not actively scanning objects.

In some embodiments, the pivot points may comprise hinges, bearings, bushings, or other mechanisms that allow the side members to fold and extend relative to the base unit. The pivot points may incorporate various types of joints or connectors that enable smooth rotation and secure positioning of the side members. In some embodiments, the mechanisms may include locking features to maintain the side members in their extended or retracted positions. In some embodiments, the locking features may include a removable pin mechanism that secures the side members in their extended or retracted positions. The pin may be inserted through aligned holes in the side member and the base unit to lock the side member in place. When adjustment is needed, the pin may be removed to allow movement of the side member.

In some embodiments, the locking features may incorporate a spring-loaded latch system. This system may automatically engage when the side member reaches its fully extended or retracted position, securing it in place. A release mechanism may be provided to disengage the latch when adjustment is required. The locking features may also include a sliding bolt mechanism in some implementations. This bolt may be integrated into the side member or base unit and can be manually slid into a corresponding slot or receptacle to lock the position. The bolt may be retracted when the user wishes to adjust the side member's position. In some embodiments, the locking features may include one or more collapsible or foldable members. This member may be integrated into the side member or base unit and may be configured to fold or collapse when the side member is in its retracted position. When extended, the foldable member may lock into place, providing structural support and stability to the side member. The collapsible nature of this locking feature may allow for a compact design when the system is not in use, while still offering robust support during operation. In some implementations, the foldable member may incorporate a series of interlocking segments that create a rigid structure when fully extended.

In some embodiments, the first and second side members may be configured to removably connect to the base unit. Various connection mechanisms may be employed to facilitate this removable attachment. For example, the side members may incorporate slot or groove connections that align with corresponding protrusions or rails on the base unit. This type of connection may allow the side members to slide into place and be secured. Other connection methods may include snap-fit mechanisms, where the side members have protruding tabs or clips that engage with matching recesses or openings in the base unit. Magnetic connections may also be utilized, with magnets embedded in both the side members and the base unit to provide a secure yet easily detachable connection. In some embodiments, the removable connection may be achieved through the use of threaded fasteners, such as screws or bolts, that can be easily inserted or removed to attach or detach the side members. Quick-release pins or latches may provide another option for rapid assembly and disassembly of the side members from the base unit. The choice of connection method may depend on factors such as the desired ease of assembly, frequency of reconfiguration, and the structural requirements of the scanning system. The removable nature of the side members may allow for more compact storage or transportation of the scanning system when not in use.

In some embodiments, the scanning system 100 may have a first length L1 when the side members 120, 130 are extended relative to the base 110. The scanning system 100 may have a second length L2 when the side members 120, 130 are retracted or removed relative to the base 110. The first length may be greater than the second length. In some embodiments, the first and second length may refer to a length of the first and second side members 120, 130 in a first direction plus a length of the table top 114 in the same first direction. In other words, the first and second length may refer to the length between a distal end of the side member 120 and a distal end of the side member 130, where distal end refers to the end of each side member that is located furthest away from a center point of the base unit. When the side members are in their extended position, the distal ends may be positioned at their maximum distance from the base unit. Conversely, when the side members are in their retracted or folded position, the distal ends may be brought closer to the base unit, reducing the overall length of the scanning system. In some embodiments, the difference between the first length and the second length may allow for flexibility in the system's footprint. The longer first length may provide an extended scanning area when the system is in operation, while the shorter second length may facilitate more compact storage or transportation of the scanning system 100 when not in use.

In some embodiments, side member 120 may include one or more raised portions 126, 128 disposed around one or more sides of the side member 120 and side member 130 may include one or more raised portions 136, 138 disposed around one or more sides of the side member 130. The raised portions may provide a safety function to keep people away from the sweep of the platform 102 and linkage 118 during operation, providing barrier that helps prevent accidental contact with moving components of the system.

In some embodiments, side member 130 may include one or more perforations 134 and side member 120 may include one or more perforations 124. The perforations may provide an indication to users that an object should not be placed on the extended side member until the platform has covered the perforation. Additionally, the perforations may reduce the overall weight of the side members, which may contribute to improved portability and ease of handling when adjusting or transporting the system. With these perforations, the side members may still effectively provide protection from the sweep of the platform 102 during operation. The perforations may be strategically placed and sized to maintain the structural integrity of the side members while achieving weight reduction. In some embodiments, the pattern and distribution of the perforations may be designed to optimize the balance between weight reduction and structural strength.

In some embodiments, the perforations in the side members may take various forms. The perforations may include openings that extend partially through the thickness of the side member, creating recesses or indentations in the surface. Alternatively, the perforations may extend fully through the side member, creating through-holes. The shape of these perforations may vary, including circular, rectangular, oval, or custom-shaped openings. In some embodiments, the perforations may form a pattern or design that enhances the aesthetic appeal of the scanning system while maintaining its functional benefits. As explained above, the size and distribution of these perforations may be tailored to optimize weight reduction and signal to users not to place objects on the extended side members, while preserving the structural integrity and protective function of the side members.

In some embodiments, a linkage 118 or linkage mechanism may connect the platform 102 to the base 110 and allow the platform to move relative to the base 110. In some embodiments, the linkage 118 may comprise one or more pivot members. In some embodiments, a pivot member 140 may have a first end connected to base 110 at a pivot point 142 and a second end connected to a pivot member 150 at an attachment point 154. In some embodiments, a pivot member 150 may be connected at a first end to pivot member 140 at attachment point 154 and may be connected at a second end to base 110 at pivot point 152. Additionally, a pivot member 160 may have a first end connected to base 110 at a pivot point 162 and a second end connected to a pivot member 170 at an attachment point 174. In some embodiments, pivot member 170 may be connected at a first end to pivot member 160 at attachment point 174 and may be connected at a second end to base 110 at pivot point 172. In some embodiments, pivot points 142, 162 may be disposed on the base 110 via attachment members 146, 166 that are slidably attached to vertical members 148, 168 of the base 110. As the platform 102 moves horizontally, the attachment members 146, 166 may move vertically up and down the vertical members 148, 168, allowing for a smooth and controlled motion of the platform 102 while maintaining its horizontal orientation throughout its range of movement.

In some embodiments, pivot member 140 may attach to the platform 102 at one or more attachment points. Similarly, pivot member 160 may attach to the platform 102 at one or more attachment points. These attachment points may provide secure connections between the pivot members and the platform, enabling controlled movement of the platform relative to the base unit. The number and positioning of these attachment points may be configured to optimize the stability and range of motion of the platform. In some implementations, the attachment points may incorporate bearings or bushings to facilitate smooth rotation and reduce friction between the pivot members and the platform. In some embodiments, the attachment points may include or incorporate one or more bearing points fixed within a linear path of motion. These bearing points may be implemented as, for example, a linear bearing to facilitate smooth and controlled movement of the platform 102 along its designated path.

In some embodiments, the linkage mechanism may be configured to allow the platform 102 to move in a path relative to the base 110, while maintaining stability through the interconnected pivot members. In some embodiments, the path of the platform 102 relative to the base 110 may be linear. This linear path may allow for precise and controlled movement of the platform during the scanning process. In some embodiments, the path may be substantially linear, which may accommodate slight deviations or variations in the movement while still maintaining a generally straight trajectory. The substantially linear path may provide flexibility in the system's operation, allowing for minor adjustments or compensations in the platform's movement without significantly impacting the scanning performance. In some embodiments, when the side members 120, 130 are in the extended state or configuration, the first and second side members may be parallel or substantially parallel to a top surface of the surface 114.

In some embodiments, the linkage may be configured to allow the platform 102 to move back and forth along a path that extends from one side member to the other by passing above or over surface 114. In some embodiments, when the system is in the extended state, the platform is configured to move along a path that extends at least partially between the first side member and the second side member. In some embodiments, when the system is in the extended state, the platform is configured to move along a path that extends at least partially between a distal end of the first side member and a distal end of the second side member. In some embodiments, the maximum or permitted path of the platform may be less than the distance L1 described above. This arrangement may provide a buffer zone between the extent of the platform's movement and the full length of the side members when in the extended state. This may allow for clearance at the ends of the travel path, accommodating any mechanical tolerances in the system. Additionally, this state may provide space for other components or features at the ends of the scanning area, such as stops, slides, sensors, or additional structural elements to prevent the platform 102 from traveling further than a predetermined path and distance of travel.

In some embodiments, the system may include a single side member (rather than two side members on opposite sides of the base). The linkage may be configured to allow the platform 102 to move back and forth along a path that extends from the single side member to the base 110 by passing above or over surface 114. This configuration may allow for a shorter length and overall more compact system in the extended state compared to systems utilizing two side members.

In some embodiments, the system may incorporate one or more springs, dashpots, counterweights or other mechanical aids to ease and/or smooth the movement of the platform along its path. These aids may be passive, or may incorporate active electronic, hydraulic, or pneumatic elements to provide assistive energy. These mechanical aids may be strategically positioned within the linkage mechanism or between the platform and the base unit to provide controlled resistance or assistance during the platform's motion. The mechanical aids may be configured to counterbalance the weight of the platform and any objects placed upon it, reducing the force required to initiate or maintain movement. In some embodiments, the mechanical aids may be designed to provide a dampening effect, helping to smooth out any abrupt movements or vibrations during the scanning process. The type, strength, and placement of the mechanical aids may be tailored to achieve specific motion characteristics, such as a consistent speed throughout the path or a gentle deceleration at the ends of the travel range. Additionally, the mechanical aid system may be adjustable, allowing operators to fine-tune the platform's movement based on the weight of the scanned objects or the desired scanning speed. This mechanically-assisted motion may contribute to more precise and repeatable scanning results while reducing wear on other mechanical components of the system.

In some embodiments, the linkage mechanism may be configured to move the platform such that the object supported on the platform moves past the at least one sensor. This movement provided by the linkage mechanism may activate or wake up certain types of sensors, including sensors that require relative motion to function properly. For example, magnetic sensors, inductive sensors, or other motion-dependent sensing technologies may require the object to be in motion relative to the sensor to generate meaningful data. The controlled movement of the platform via the linkage mechanism may create the necessary relative motion between the object and the sensor, enabling effective detection and data collection. This integration of movement and sensing capabilities may allow the system to capture dynamic information about the object that might not be obtainable in a static configuration. Additionally, the precise and consistent motion provided by the linkage mechanism may ensure reliable sensor activation and data collection throughout the scanning process, improving the accuracy and completeness of the information gathered about the object. The activation of sensors only when the platform is in motion may also help conserve energy and prolong sensor life, as the sensors can remain in a low-power or sleep mode when not actively scanning, and only power up fully when movement is detected.

In some embodiments, the linkage mechanism may be configured to support the weight of the object positioned on the platform 102. The platform 102 may be configured to travel along a path that passes over the top of surface 114 and the side members 120, 130 without making physical contact with these components. This configuration may allow the weight of the object to be distributed through the linkage mechanism rather than being borne by the side elements or the base unit. By transferring the load through the linkage mechanism, the system may achieve improved stability and durability while reducing stress on other components of the scanning system. This design approach may also contribute to more accurate scanning results by maintaining consistent positioning of the object during the scanning process, as the linkage mechanism provides reliable support throughout the platform's range of motion.

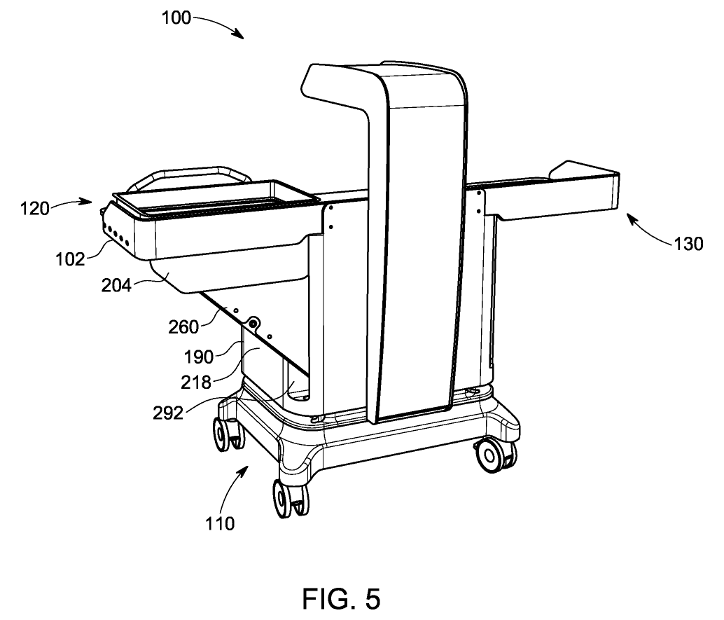

In some embodiments, as will also be described in reference to FIG. 5 below, one or more side guards 104, 204 of the platform 102 may be located on opposite sides of platform 102 and base 110. The side guards may extend along at least a portion of the length of the platform 102 and travel with the platform 102, and may provide a safety barrier against pinch points within the linkage system. Additionally, the guards may help guide the platform 102 in its path of travel. The positioning of the side guards on opposite sides may provide balanced support and guidance for the platform's movement. As the platform 102 moves along its path, the side guards 104, 204 may act as a guide rail system, ensuring that the platform maintains a consistent and controlled trajectory. This arrangement may help prevent lateral deviation of the platform during operation, contributing to the accuracy and reliability of the scanning process. The side guards may also serve to protect the internal mechanisms of the scanning system from external interference while the platform is in motion.

In some embodiments, one or more components of the linkage 118 may include additional safety features or design aspects. In some embodiments, pivot member 140 may include a central region 144 that includes an increased width relative to the portions of pivot member 140 proximate its attachment point to platform 102 and proximate pivot point 142, and/or pivot member 160 may include a central region 164 that includes an increased width relative to the portions of pivot member 160 proximate its attachment point to platform 102 and proximate pivot point 162. These regions of increased width may extend for at least a portion of the length of the pivot members 140, 160. In some embodiments, the regions 144, 164 may help prevent a user's extremities from becoming entangled or trapped within the linkage 118 during operation. The increased width of these regions may create a physical barrier that reduces the likelihood of fingers, hands, or other body parts inadvertently entering spaces between moving components of the linkage 118.

In some embodiments, the scanning system 100 may include one or more weight sensors 182, 184. In some embodiments, these weight sensors may be implemented as load cells, which are transducers that convert force into a measurable electrical output. The load cells may be positioned at strategic locations within the system to accurately measure the weight of objects placed on the platform 102. In some embodiments, the weight sensors 182, 184 may be located at fixed bearing points of the linkage 118.

In some embodiments, the fixed bearing points may be integrated into the pivot points where the linkage mechanism attaches to the base unit, such as pivot points 142, 152, 162, and/or 172. In some embodiments, the weight sensors may be located at the top pivot points 152 and 172. By positioning the weight sensors at these specific pivot points, the system may achieve accurate and consistent weight measurements. For example, the top pivot points 152 and 172 may remain relatively stationary compared to other parts of the linkage mechanism during the platform's movement. This stability may allow for more precise weight sensing, as these points may experience less dynamic forces and vibrations during operation. The fixed nature of these top pivot points may provide a more reliable reference for weight measurements throughout the scanning process.

In some embodiments, the fixed bearing points may provide stable and consistent locations for weight sensing, improving the accuracy and reliability of the measurements. In some embodiments, the fixed bearing points may be designed to remain stationary relative to the moving parts of the linkage mechanism, allowing the weight sensors to capture accurate force measurements as the platform moves. By positioning weight sensors at these fixed points, the system may be able to measure the weight of objects on the platform more precisely, as the forces are transferred through the linkage mechanism to these stable measurement locations.

In some embodiments, the positioning of weight sensors at the fixed bearing points of the linkage may allow for distributed weight sensing across multiple points, which may enhance the system's ability to accurately measure objects of various sizes and weight distributions. This configuration may also help isolate the weight measurements from interference caused by the movement of the platform, as the fixed points remain stationary during the scanning process. In some embodiments, the use of weight sensors at these locations may enable the system to perform dynamic weight measurements as the platform moves along its path. This capability may provide additional data points for analysis, enhancing the overall scanning and detection capabilities of the system.

In some embodiments, alternative or additional weight measuring mechanisms may be employed at these fixed bearing points or other locations. For example, strain gauges may be utilized, which measure the deformation of a material under applied force and convert this deformation into an electrical signal proportional to the weight. Alternative weight sensing technologies such as piezoelectric sensors or hydraulic load cells may also be considered for integration at these fixed points of the linkage mechanism.

In some embodiments, one or more wheels 112 may enable the entire scanning system 100 to be readily repositioned as needed. In some embodiments, the wheels 112 may be retractable, allowing the scanning system 100 to be lowered and stabilized when in a stationary operating position while still maintaining the ability to be easily moved when needed.

In some embodiments, the scanning system 100 may include one or more processors configured to receive and process data collected by the at least one sensor. The processor may be integrated within the base 110 or housed in a separate control module connected to the scanning system. The processor may be configured to derive various types of information about the scanned object from the received sensor data. This information may include physical characteristics such as the object's dimensions, shape, density, and material composition. In some cases, the processor may utilize advanced signal processing and machine learning algorithms to extract detailed features from the raw sensor data.

In some embodiments, the derived information may be further analyzed by the processor to generate more complex assessments of the scanned object. This analysis may involve comparing the derived object characteristics against known patterns or profiles stored in a database. The processor may employ statistical models, neural networks, or other computational techniques to evaluate the object data. Based on this analysis, the processor may generate a risk estimation associated with the scanned object. This risk estimation may indicate the likelihood that the object contains prohibited or dangerous materials. The risk estimation may be expressed as a numerical score, probability, or categorical classification (e.g. low, medium, high risk).

In some embodiments, the risk estimation process may consider multiple factors beyond just the physical characteristics of the object. For example, the processor may incorporate contextual information such as the scanning location, time of day, or recent security alerts externally provided through an application programming interface into its risk calculations. The risk estimation algorithm may be periodically updated and refined to improve its accuracy and adapt to emerging threat patterns.

In some embodiments, the processor may output the risk estimation results through a user interface, allowing operators to quickly assess potential security risks. In some embodiments, the system may be configured to automatically trigger certain actions, such as additional screening procedures, based on the generated risk estimation.

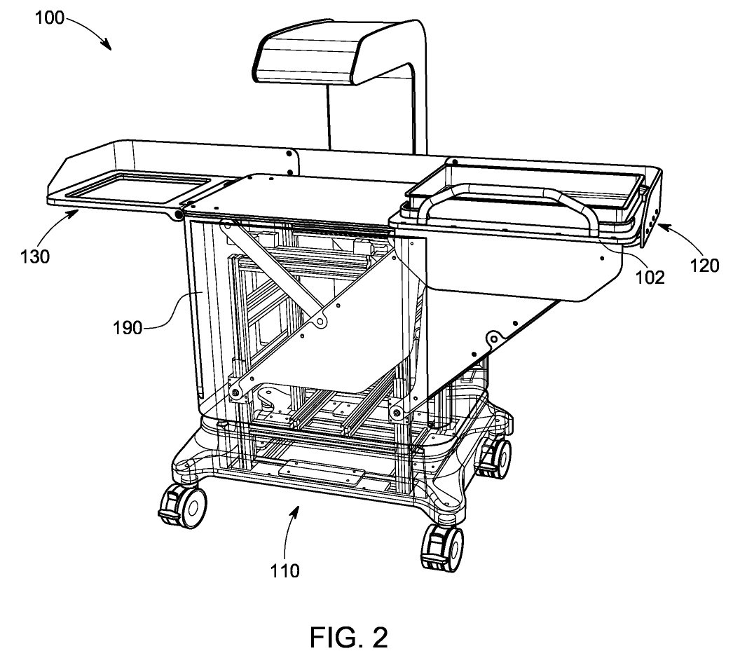

FIGS. 2-5 depict additional views of the exemplary scanning system 100. The same reference characters described above in reference to FIG. 1 apply to like components in FIGS. 2-5, where applicable.

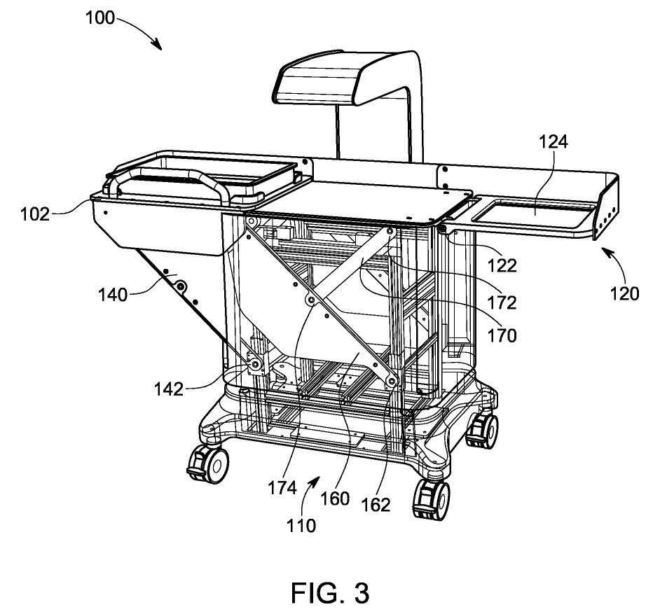

FIGS. 2 and 3 depict movement of the platform 102 along its path of travel. As shown in FIG. 2, the platform 102 may be positioned such that it extends above side member 120 at a first end of its path of travel when the side members 120, 130 are in their extended state. As shown in FIG. 3, the platform 102 may be positioned such that it extends above side member 130 at a second opposite end of its path of travel when the side members 120, 130 are in their extended state. This positioning may illustrate a range of motion of the platform 102 as it moves along its path of travel between respective distal ends of the extended side members 120, 130.

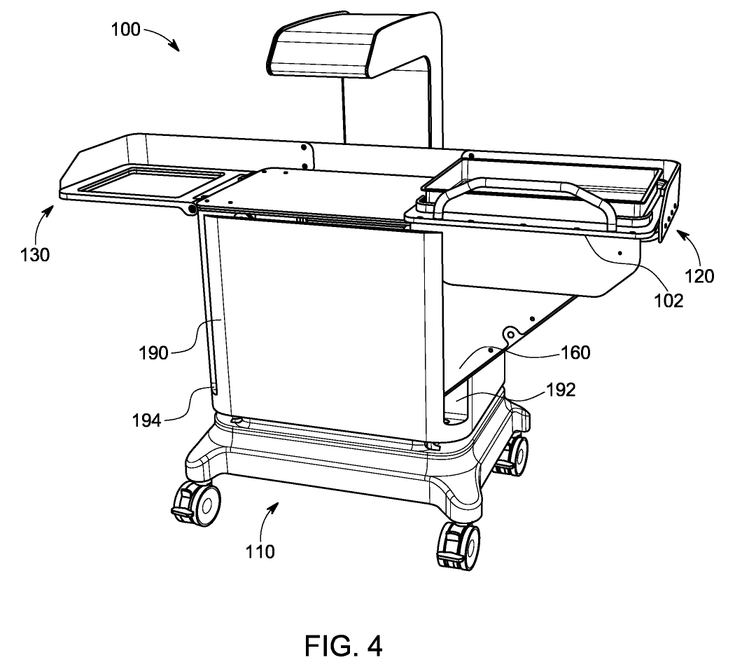

FIG. 4 depicts a view of the exemplary scanning system 100 in an assembled configuration. In some embodiments, the system may include at least one cover 190. In some embodiments, the cover 190 may be integrated into or positioned onto the base 110, providing protection for internal components and limiting accessibility to the movable components of the linkage mechanism. The cover 190 may be constructed as a single integral piece or may comprise multiple assembled components that together form the complete cover structure. The cover may include one or more openings 192, 194. In some embodiments, pivot member 160 may extend through a first opening 192 on a first side of the cover 190 during movement of the platform towards side member 120 and pivot member 140 may extend through a second opening 194 on a second side of the cover 190 during movement of the platform towards side member 130.

FIG. 5 depicts a rear view of the exemplary scanning system 100. In some embodiments, the rear side of the scanning system 100 may have mirroring or corresponding components to those shown on the front side. In some embodiments, the rear side components that mirror those on the front side are configured to have similar functionality and arrangement to the corresponding front side components. Certain examples are discussed below in reference to FIG. 5 for illustrative purposes. For brevity, each of the mirrored components is not described in detail herein, as their operation and purpose may be understood by reference to the corresponding front side components previously explained.

For example, in some embodiments and as described above, a side guard 204 may be located on an opposite of the platform 102 from side guard 104 for safety (e.g., to protect pinch points within the linkage 118) and to help guide the platform 102. In some embodiments, a second linkage system 218 may mirror the linkage system 118 described in reference to FIGS. 1-4. The second linkage system may include, for example, a pivot member 260 that mirrors the pivot member 160 shown in FIG. 4. The second pivot member 260 may extend through an opening 292 located on the rear side of the cover 192 that mirrors the opening 192 shown in FIG. 4.

In some embodiments, the rear side of the scanning system 100 may incorporate weight sensors similar to those described in reference to the front side shown in FIGS. 1-4. For example, the rear side may include one or more weight sensors, such as load cells, positioned proximate respective fixed bearing points of the linkage mechanism 218. In some embodiments, the weight sensors on the rear side may be disposed at locations that correspond to the weight sensors 182, 184 on the front side. For instance, weight sensors may be integrated into or proximate the pivot points where the rear linkage mechanism attaches to the base unit, mirroring the arrangement of the front side. The inclusion of weight sensors on both the front and rear sides of the scanning system may enhance its ability to measure objects of various sizes and weight distributions. This arrangement may also contribute to more precise weight sensing by allowing the system to account for imbalances or shifts in weight distribution as the platform moves along its scanning path.

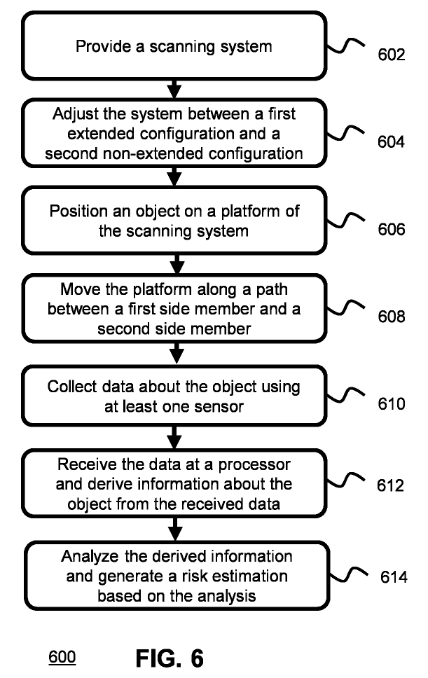

FIG. 6 depicts a flowchart of an exemplary process 600 for scanning an object.

At step 602, a scanning system may be provided. The scanning system may include a platform configured to support an object to be scanned, a base unit configured to engage a ground surface, a linkage coupled to the platform, at least one side member configured to connect to a side of the base, and at least one sensor configured to collect data about the object. In some embodiments, the system may include a first side member configured to connect to the base unit at a first side and a second side member configured to connect to the base unit at a second side. The linkage mechanism may be configured to allow the platform to move relative to the base unit while supporting the weight of the object positioned on the platform. The at least one sensor may include a sensor array comprising one or more radar sensors and/or optical depth sensors, each configured to collect different types of data about the object. The system may also include at least one weight sensor, such as a plurality of load cells, configured to collect data indicative of a weight of the object. These weight sensors may be positioned proximate respective fixed bearing points of the linkage mechanism.

At step 604, the system may be adjusted between a first state and a second state. In the first state, the first and second side members are extended relative to the base unit, with the first and second side members being substantially parallel to a top surface of the base unit. In this extended state, the first and second side members and the base unit collectively have a first length. In the second state, the first and second side members are not extended relative to the base unit, resulting in the system having a second length that is less than the first length. The adjustment between states may involve pivoting the side members, as they may be pivotably connected to the base unit, or removing and reattaching them if they are removably connected to the base unit. The side members may include surfaces with one or more perforations to reduce weight while maintaining structural integrity.

In some embodiments, step 604 may be utilized for adjusting the system between a travel or storage state and a use state. The second state, where the first and second side members are not extended relative to the base unit, may serve as a compact travel or storage state. This state may allow for easier transportation of the scanning system, as the reduced length may facilitate fitting the system into vehicles, through doorways, or into storage spaces with limited dimensions. The first state, where the first and second side members are extended relative to the base unit, may serve as the use state. This extended state may provide a larger scanning area and improved stability during operation. The ability to adjust between these states may enhance the versatility of the scanning system, allowing it to be efficiently stored or transported when not in use, and quickly deployed for scanning operations when needed. The adjustment process may involve simple actions such as pivoting the side members or removing and reattaching them, depending on the specific design of the system, potentially allowing for rapid transitions between states in various operational scenarios.

At step 606, an object may be positioned on the platform of the scanning system. The object may be any item that requires scanning or inspection, such as luggage, packages, or personal belongings. The platform may include a tray specifically designed to hold the object securely during the scanning process. The linkage mechanism, which may comprise a first pivot member pivotally connected to the base unit at a first pivot point, a second pivot member pivotally connected to the base unit at a second pivot point, a third pivot member connected to the first member and pivotally connected to the base unit at a third pivot point, and a fourth pivot member connected to the second member and pivotally connected to the base unit at a fourth pivot point, may be configured to support the weight of the object on the platform throughout the scanning process.

At step 608, the platform may be moved along a path. In some embodiments, the path may extend between a distal end of the first side member and a distal end of the second side member when the system is in the first state. This movement may allow the object to pass over the base unit and through the scanning area. The path may be substantially linear, with the platform moving in a controlled manner due to the linkage mechanism. The first and second side members may be configured to extend beyond the range of movement of the platform in a distal direction when the system is in the first state, providing safety barriers. The third pivot member may be connected to the platform at a first attachment point, and the fourth pivot member may be connected to the platform at a second attachment point, enabling smooth and stable movement of the platform along its path. A handle may be provided on the platform to move the platform.

At step 610, data about the object may be collected using the at least one sensor. The sensor may include various types of detection equipment, such as radio wave, radar, magnetic, inductive, optical, X-ray scanners, metal detectors, or chemical trace detectors, depending on the specific application of the scanning system. The movement of the platform provided by the linkage mechanism may activate the at least one sensor, as one or more of the sensors may require relative motion to function properly. As the object moves past the sensors housed in the housing member extending from the base unit, comprehensive data about the object's physical characteristics, internal contents, and other relevant properties may be gathered. The weight sensors positioned at fixed bearing points of the linkage mechanism may simultaneously collect precise weight data about the object.

At step 612, the collected data may be received at a processor, and information about the object may be derived from the received data. This step may involve analyzing the raw sensor data to extract meaningful information about the object's characteristics, contents, or potential risks. The processor may be integrated within the base unit or housed in a separate control module connected to the scanning system. The processor may utilize advanced signal processing and machine learning algorithms to extract detailed features from the raw sensor data, including physical characteristics such as the object's dimensions, shape, density, and material composition. The weight data from the load cells may be processed to determine the precise weight of the object, which may be used as an additional parameter in the analysis.

At step 614, the derived information may be analyzed and a risk estimation may be generated based on the analysis. This risk estimation may provide an assessment of any potential threats or concerns associated with the scanned object. The processor may compare the derived object characteristics against known patterns or profiles stored in a database and employ statistical models, neural networks, or other computational techniques to evaluate the object data. The risk estimation may be expressed as a numerical score, probability, or categorical classification (e.g., low, medium, high risk). The system may be configured to automatically trigger certain actions, such as additional screening procedures, based on the generated risk estimation.

In some embodiments, the process 600 may be iterative, allowing for multiple objects to be scanned in succession. The system may return to step 606 after completing step 614, ready to scan the next object. In some cases, the process may include additional steps such as user interface interactions, data storage, or communication with external systems. The mobility provided by the wheels on the base unit allows the scanning system to be easily repositioned between scanning sessions if needed.

The process 600 may provide a systematic approach to object scanning, combining physical movement of the object through the scanning area with data collection, analysis, and risk assessment. This integrated process may enable efficient and thorough examination of objects in various security, logistics, or quality control applications. The adjustable configuration of the system between extended and non-extended states provides flexibility for different operational environments, allowing for efficient use of space when not in active scanning mode while providing a comprehensive scanning area when deployed.

### COMPUTER SYSTEM

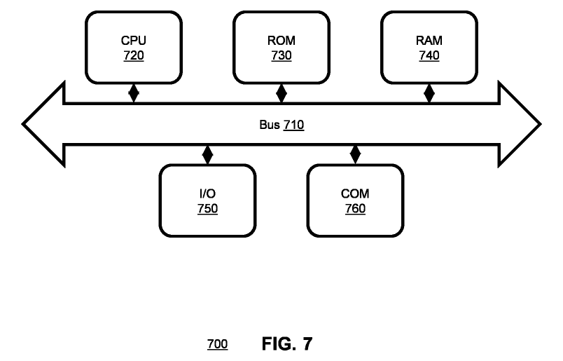

FIG. 7 depicts an example system that may execute techniques presented herein. FIG. 7 is a simplified functional block diagram of a computer that may be configured to execute techniques described herein, according to exemplary cases of the present disclosure. Specifically, the computer (or “platform” as it may not be a single physical computer infrastructure) may include a data communication interface 760 for packet data communication. The platform may also include a central processing unit 720 (“CPU 720”), in the form of one or more processors, for executing program instructions. The platform may include an internal communication bus 710, and the platform may also include a program storage and/or a data storage for various data files to be processed and/or communicated by the platform such as ROM 730 and RAM 740, although the system 700 may receive programming and data via network communications. The system 700 also may include input and output ports bto connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In some cases, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

### TERMINOLOGY

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of ±10% in a stated value.

The term “exemplary” is used in the sense of “example” rather than “ideal.” As used herein, the singular forms “a,” “an,” and “the” include plural reference unless the context dictates otherwise.

### EXAMPLES

Exemplary embodiments of the systems and methods disclosed herein are described in the numbered paragraphs below.

A1. A system for scanning an object, the system comprising:

a platform configured to support an object to be scanned;

a base configured to engage a ground surface;

a linkage coupled to the platform, wherein the linkage allows the platform to move relative to the base;

at least one side member configured to connect to the base at a side of the base; and

at least one sensor configured to collect data about the object;

wherein the system is adjustable between:

a first state wherein the at least one side member is extended relative to the base; and

a second state wherein the at least one side member is not extended relative to the base;

wherein, when the system is in the first state, the platform is configured to move along a path that extends above the at least one side member and the base.

A2. The system of A1, wherein:

when the system is in the first state, the at least one side member is configured such that the system has a first length;

when the system is in the second state, the at least one side member is configured such that the system has a second length; and

wherein the second length is less than the first length.

A3. The system of A1 or A2, wherein the at least one side member comprises a first side member configured to connect to the base at a first side of the base and a second side member configured to connect to the base at a second side of the base; and wherein, when the system is in the first state, the first and second side members are substantially parallel to a top surface of the base and the platform is configured to move along a substantially linear path that extends at least partially between the first side member and the second side member.

A4. The system of any of A1-A3, wherein the linkage is configured to support the weight of the object on the platform.

A5. The system of any of A1-A4, further comprising a processor configured to:

receive the data collected by the at least one sensor, and

derive information about the object from the received data.

A6. The system of A5, wherein the processor is further configured to:

analyze the derived information about the object; and

generate a risk estimation based on the analysis.

A7. The system of any of A1-A6, further comprising at least one weight sensor configured to collect data indicative of a weight of the object.

A8. The system of any of A7, wherein the at least one weight sensor includes a plurality of load cells.

A9. The system of any of A7 or A8, wherein the at least one weight sensor comprises a plurality of weight sensors, wherein each of the plurality of weight sensors is positioned proximate a respective fixed bearing point of the linkage.

A10. The system of any of A1-A9, wherein:

the linkage is configured to move the platform such that the object supported on the platform moves past the at least one sensor; and

the movement of the platform provided by the linkage activates the at least one sensor.

A11. The system of any of A1-A10, wherein the at least one side member is removably connected to the base.

A12. The system of any of A1-A11, wherein the at least one side member is pivotably connected to the base.

A13. The system of any of A1-A12, wherein the linkage comprises:

a first pivot member pivotally connected to the base at a first pivot point;

a second pivot member pivotally connected to the base at a second pivot point;

a third pivot member connected to the first member and pivotally connected to the base at a third pivot point; and

a fourth pivot member connected to the second member and pivotally connected to the base at a fourth pivot point.

A14. The system of A13, wherein:

the third pivot member is connected to the platform at a first attachment point; and

the fourth pivot member is connected to the platform at a second attachment point.

A15. The system of any of A1-A14, wherein the at least one side member comprises a surface with one or more perforations.

A16. The system of any of A1-A15, wherein the at least one side member is configured to extend beyond a range of movement of the platform in a distal direction when the system is in the first state.

A17. A method for scanning an object, the method comprising:

providing a system comprising:

a platform configured to support an object to be scanned;

a base configured to engage a ground surface;

a linkage coupled to the platform, wherein the linkage allows the platform to move relative to the base;

at least one side member configured to connect to the base at a side of the base; and

at least one sensor configured to collect data about the object;

adjusting the system between:

a first state wherein the at least one side member is extended relative to the base; and

a second state wherein the at least one side member is not extended relative to the base;

positioning the object on the platform;

moving the platform along a path that extends above the at least one side member and the base when the system is in the first state; and

collecting data about the object using the at least one sensor.

A18. The method of A17, wherein:

when the system is in the first state, the at least one side member is configured such that the system has a first length;

when the system is in the second state, the at least one side member is configured such that the system has a second length; and

wherein the second length is less than the first length.

A19. The method of A17 or A18, wherein the at least one side member comprises a first side member configured to connect to the base at a first side of the base and a second side member configured to connect to the base at a second side of the base; and wherein, when the system is in the first state, the first and second side members are substantially parallel to a top surface of the base and the platform is configured to move along a substantially linear path that extends at least partially between the first side member and the second side member.

Other aspects of the disclosure will be apparent to those skilled in the art from consideration of the specification and practice of the invention disclosed herein. It is intended that the specification and examples be considered as exemplary only, with a true scope and spirit of the invention being indicated by the following claims.

1. A system for scanning an object, the system comprising:
a platform configured to support an object to be scanned;
a base configured to engage a ground surface;
a linkage coupled to the platform, wherein the linkage allows the platform to move relative to the base;
at least one side member configured to connect to the base at a side of the base; and
at least one sensor configured to collect data about the object;
wherein the system is adjustable between:
a first state wherein the at least one side member is extended relative to the base; and
a second state wherein the at least one side member is not extended relative to the base;
wherein, when the system is in the first state, the platform is configured to move along a path that extends above the at least one side member and the base.

2. The system of claim 1, wherein:
when the system is in the first state, the at least one side member is configured such that the system has a first length;
when the system is in the second state, the at least one side member is configured such that the system has a second length; and
wherein the second length is less than the first length.

3. The system of claim 1, wherein the at least one side member comprises a first side member configured to connect to the base at a first side of the base and a second side member configured to connect to the base at a second side of the base; and
wherein, when the system is in the first state, the first and second side members are substantially parallel to a top surface of the base and the platform is configured to move along a substantially linear path that extends at least partially between the first side member and the second side member.

4. The system of claim 1, wherein the linkage is configured to support the weight of the object on the platform.

5. The system of claim 1, further comprising a processor configured to:
receive the data collected by the at least one sensor, and
derive information about the object from the received data.

6. The system of claim 5, wherein the processor is further configured to:
analyze the derived information about the object; and
generate a risk estimation based on the analysis.

7. The system of claim 1, further comprising at least one weight sensor configured to collect data indicative of a weight of the object.

8. The system of claim 7, wherein the at least one weight sensor includes a plurality of load cells.

9. The system of claim 7, wherein the at least one weight sensor comprises a plurality of weight sensors, wherein each of the plurality of weight sensors is positioned proximate a respective fixed bearing point of the linkage.

10. The system of claim 1, wherein:
the linkage is configured to move the platform such that the object supported on the platform moves past the at least one sensor; and
the movement of the platform provided by the linkage activates the at least one sensor.

11. The system of claim 1, wherein the at least one side member is removably connected to the base.

12. The system of claim 1, wherein the at least one side member is pivotably connected to the base.

13. The system of claim 1, wherein the linkage comprises:
a first pivot member pivotally connected to the base at a first pivot point;
a second pivot member pivotally connected to the base at a second pivot point;
a third pivot member connected to the first member and pivotally connected to the base at a third pivot point; and
a fourth pivot member connected to the second member and pivotally connected to the base at a fourth pivot point.

14. The system of claim 13, wherein:
the third pivot member is connected to the platform at a first attachment point; and
the fourth pivot member is connected to the platform at a second attachment point.

15. The system of claim 1, wherein the at least one side member comprises a surface with one or more perforations.

16. The system of claim 1, wherein the at least one side member is configured to extend beyond a range of movement of the platform in a distal direction when the system is in the first state.

17. A method for scanning an object, the method comprising:
providing a system comprising:
a platform configured to support an object to be scanned;
a base configured to engage a ground surface;
a linkage coupled to the platform, wherein the linkage allows the platform to move relative to the base;
at least one side member configured to connect to the base at a side of the base; and
at least one sensor configured to collect data about the object;
adjusting the system between:
a first state wherein the at least one side member is extended relative to the base; and
a second state wherein the at least one side member is not extended relative to the base;
positioning the object on the platform;
moving the platform along a path that extends above the at least one side member and the base when the system is in the first state; and
collecting data about the object using the at least one sensor.

18. The method of claim 17, wherein:
when the system is in the first state, the at least one side member is configured such that the system has a first length;
when the system is in the second state, the at least one side member is configured such that the system has a second length; and
wherein the second length is less than the first length.

19. The method of claim 17, wherein the at least one side member comprises a first side member configured to connect to the base at a first side of the base and a second side member configured to connect to the base at a second side of the base; and
wherein, when the system is in the first state, the first and second side members are substantially parallel to a top surface of the base and the platform is configured to move along a substantially linear path that extends at least partially between the first side member and the second side member.

20. The method of claim 17, wherein the linkage is configured to support the weight of the object on the platform.
